(19) United States
(12) Patent Application Publication
(10) Pub. No.: US 2014/0236427 A1
(43) Pub. Date: Aug. 21, 2014

(54) ELECTRIC POWER STEERING CONTROL APPARATUS AND METHOD

(71) Applicant: MANDO CORPORATION, Pyeongtaek-si (KR)

(72) Inventor: Seong-Joo KIM, Seongnam-si (KR)

(73) Assignee: MANDO CORPORATION, Pyeongtaek-si (KR)

(21) Appl. No.: 14/182,947

(22) Filed: Feb. 18, 2014

(30) Foreign Application Priority Data
Feb. 20, 2013 (KR) 10-2013-0018219

(51) Int. Cl. B62D 5/04

(52) U.S. Cl. CPC B62D 5/046
USPC 701/41

(57) ABSTRACT

Disclosed herein are an electric power steering control apparatus and method. The electric power steering control apparatus includes a first determination unit which determines whether or not first current torque estimation information is in a first state of being out of a preset first reference torque estimation information range, a second determination unit which determines, if the first current torque estimation information is determined to be in the first state, whether or not second current torque estimation information is in a second state of being out of a preset second reference torque estimation information range, a drive unit which drives or shuts off an EPS device depending upon at least one determination of the first and second determination units, and a control unit which controls the drive unit so that the EPS device is driven or shut off.

### CROSS-REFERENCE TO RELATED APPLICATION

This application claims the benefit of Korean Patent Application No. 2013-0018219, filed on Feb. 20, 2013 in the Korean Intellectual Property Office, the disclosure of which is incorporated herein by reference.

### BACKGROUND

1. Field

Embodiments of the present invention relate to an electric power steering control apparatus and method.

2. Description of the Related Art

In general, a conventional EPS (Electric Power Steering) device is provided to reduce steering force applied to a steering wheel by a driver during low-speed driving or parking of a vehicle.

However, since the conventional EPS device has a limitation in estimating a current torque value during failure of a torque sensor, there is a limitation in stably controlling a posture of the vehicle.

Accordingly, in recent years, a study on an improved electric power steering control apparatus and method, by which a vehicle is stably driven by rapidly estimating a current torque value to stably control a posture of the vehicle during failure of a torque sensor so as to enable traffic accidents to be previously prevented, has been continuously conducted.

In addition, in recent years, a study on an improved electric power steering control apparatus and method, by which a driver rapidly recognizes abnormal current condition of a torque sensor and rapidly copes with the present condition during failure of the torque sensor so as to enable traffic accidents to be further previously prevented, has been continuously conducted.

### SUMMARY

Therefore, it is an aspect of the present invention to provide an electric power steering control apparatus and method by which a vehicle is stably driven so as to enable traffic accidents to be previously prevented.

It is another aspect of the present invention to provide an electric power steering control apparatus and method by which a driver rapidly copes with the present condition so as to enable traffic accidents to be further previously prevented.

Additional aspects of the invention will be set forth in part in the description which follows and, in part, will be obvious from the description, or may be learned by practice of the invention.

In accordance with one aspect of the present invention, an electric power steering control apparatus includes a first determination unit which determines whether or not first current torque estimation information sensed by a first torque sensor is in a first state of being out of a preset first reference torque estimation information range, a second determination unit which determines, if the first current torque estimation information is determined to be in the first state, whether or not second current torque estimation information sensed by a second torque sensor is in a second state of being out of a preset second reference torque estimation information range, a drive unit which drives or shuts off an EPS (Electric Power Steering) device depending upon at least one determination of the first and second determination units, and a control unit which controls the drive unit so that the EPS device is driven if the first current torque estimation information is not determined to be in the first state or the second current torque estimation information is not determined to be in the second state, or the EPS device is shut off if the first current torque estimation information is determined to be in the first state or the second current torque estimation information is determined to be in the second state.

After effectiveness of a current steering angle is identified by the first and second current torque estimation information, a current torque value may be estimated using a current vehicle speed range and the current steering angle.

A current torque value may be estimated by the first and second current torque estimation information by means of additionally using correlation information between a current vehicle speed and a current steering angle, between a current lateral acceleration and a current gravitational acceleration, and between a wheelbase and an understeer gradient.

The apparatus may further include a first identification unit which identifies abnormal condition of the first torque sensor if the first current torque estimation information is determined to be in the first state.

The apparatus may further include a second identification unit which identifies abnormal condition of the second torque sensor if the second current torque estimation information is determined to be in the second state.

The apparatus may further include a third identification unit provided such that, when the EPS device is shut off and a shut-off feedback signal is supplied from the control unit, shut-off condition of the EPS device is identified according to control of the control unit.

In accordance with another aspect of the present invention, an electric power steering control method includes performing a first current torque estimation signal output operation in which first current torque estimation information is sensed and output, performing a first determination operation in which it is determined whether or not the first current torque estimation information is in a first state of being out of a first reference torque estimation information range, performing a second current torque estimation signal output operation in which second current torque estimation information is sensed and output if the first current torque estimation information is determined to be in the first state, performing a second determination operation in which it is determined whether or not second current torque estimation information is in a second state of being out of a second reference torque estimation information range, and performing a drive operation in which an EPS device is driven if the first current torque estimation information is not determined to be in the first state or the second current torque estimation information is not determined to be in the second state, or the EPS device is shut off if the first current torque estimation information is determined to be in the first state or the second current torque estimation information is determined to be in the second state.

After effectiveness of a current steering angle is identified by the first and second current torque estimation information, a current torque value may be estimated using a current vehicle speed range and the current steering angle.

A current torque value may be estimated by the first and second current torque estimation information by means of additionally using correlation information between a current vehicle speed and a current steering angle, between a current lateral acceleration and a current gravitational acceleration, and between a wheelbase and an understeer gradient.

The method may further include performing, after performing the first determination operation, a first identification operation in which abnormal condition of a first torque sensor is identified if the first current torque estimation information is determined to be in the first state.

The method may further include performing, after performing the second determination operation, a second identification operation in which abnormal condition of a second torque sensor is identified if the second current torque estimation information is determined to be in the second state.

The method may further include performing, after performing the drive operation, a third identification operation in which, when the EPS device is shut off and a shut-off feedback signal is supplied, shut-off condition of the EPS device is identified.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating a connected state of an electric power steering control apparatus according to a first embodiment of the present invention to first and second torque sensors and an EPS device;

FIG. 2 is a block diagram illustrating an exemplary configuration of the electric power steering control apparatus shown in FIG. 1;

FIG. 3 is a graph illustrating a process of estimating a current torque value using a current vehicle speed range and a current steering angle;

FIG. 4 is a flowchart illustrating an electric power steering control method of the electric power steering control apparatus according to the first embodiment of the present invention;

FIG. 5 is a block diagram illustrating an exemplary configuration of an electric power steering control apparatus according to a second embodiment of the present invention;

FIG. 6 is a flowchart illustrating an electric power steering control method of the electric power steering control apparatus according to the second embodiment of the present invention;

FIG. 7 is a block diagram illustrating an exemplary configuration of an electric power steering control apparatus according to a third embodiment of the present invention;

FIG. 8 is a flowchart illustrating an electric power steering control method of the electric power steering control apparatus according to the third embodiment of the present invention;

FIG. 9 is a block diagram illustrating an exemplary configuration of an electric power steering control apparatus according to a fourth embodiment of the present invention; and

FIG. 10 is a flowchart illustrating an electric power steering control method of the electric power steering control apparatus according to the fourth embodiment of the present invention.

### DETAILED DESCRIPTION

Reference will now be made in detail to the embodiments of the present invention, examples of which are illustrated in the accompanying drawings, wherein like reference numerals refer to like elements throughout.

### First Embodiment

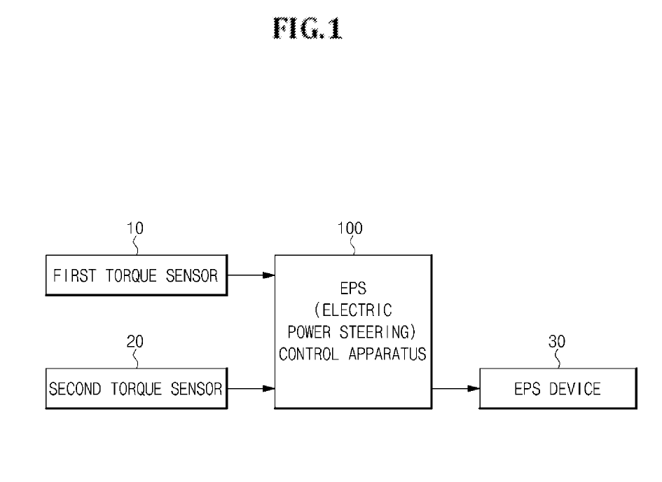

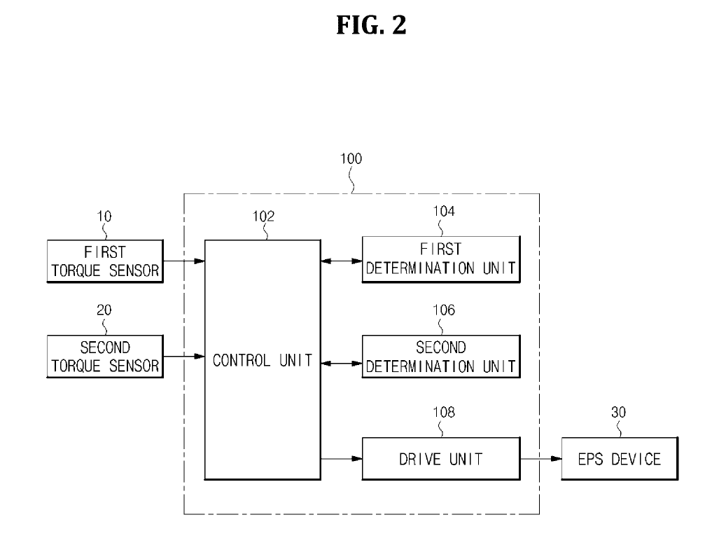

FIG. 1 is a block diagram illustrating a connected state of an electric power steering control apparatus according to a first embodiment of the present invention to first and second torque sensors and an EPS device. FIG. 2 is a block diagram illustrating an exemplary configuration of the electric power steering control apparatus shown in FIG. 1.

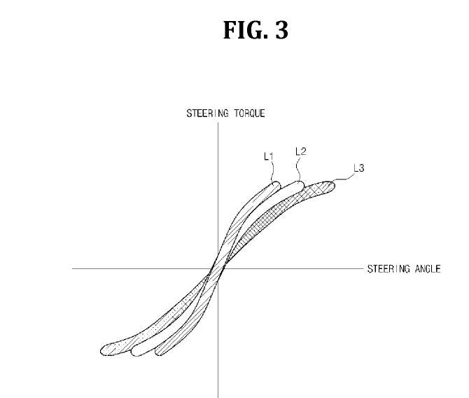

FIG. 3 is a graph illustrating a process of estimating a current torque value using a current vehicle speed range and a current steering angle.

As shown in FIGS. 1 to 3, an electric power steering control apparatus 100 according to a first embodiment of the present invention includes a control unit 102, a first determination unit 104, a second determination unit 106, and a drive unit 108.

The first determination unit 104 determines whether or not first current torque estimation information sensed by a first torque sensor 10 is in a first state of being out of a preset first reference torque estimation information range.

If the first current torque estimation information sensed by the first torque sensor 10 is determined to be in the first state of being out of the preset first reference torque estimation information range, the second determination unit 106 determines whether or not second current torque estimation information sensed by a second torque sensor 20 is in a second state of being out of a preset second reference torque estimation information range.

In this case, after effectiveness of a current steering angle is identified by the first and second current torque estimation information, a current torque value may be estimated using a current vehicle speed range and the current steering angle.

For example, the current torque value may be estimated according to current steering angles when the current vehicle speed is in a high speed range L1 (for instance, 160 kph), when the current vehicle speed is in a middle speed range L2 (for instance, 100 kph), and when the current vehicle speed is in a low speed range L3 (for instance, 60 kph), as shown in FIG. 3.

In addition, the current torque value may be estimated by the first and second current torque estimation information by means of additionally using correlation information between a current vehicle speed and a current steering angle, between a current lateral acceleration and a current gravitational acceleration, and between a wheelbase and an understeer gradient, which is indicated by the following Equation 1:

$$\frac{{a}_{y}}{δ} = \frac{\frac{{V}^{2}}{57.3 Lg}}{1 + \frac{K {V}^{2}}{57.3 Lg}} ( deg \text{/} sec ) \qquad [ Equation 1 ]$$

where “a_{y}” denotes a lateral acceleration, “δ” denotes a steering angle, “V” denotes a vehicle speed, “L” denotes a wheelbase, “K” denotes an understeer gradient, and “g” denotes a gravitational acceleration.

The drive unit 108 drives or shuts off an EPS (Electric Power Steering) device 30 depending upon at least one determination of the first and second determination units 104 and 106.

If the first current torque estimation information is not determined to be in the first state or the second current torque estimation information is not determined to be in the second state, the control unit 102 controls the drive unit 108 such that the EPS device 30 is driven.

On the other hand, if the first current torque estimation information is determined to be in the first state or the second current torque estimation information is determined to be in the second state, the control unit 102 controls the drive unit 108 such that the EPS device 30 is shut off.

In this case, the control unit 102, the first determination unit 104, the second determination unit 106, and the drive unit 106 may control overall operation of the vehicle using a main computer applied thereto, or control overall operation of the vehicle by a typical ECU (Electric Control Unit) (not shown) which controls inner operation of an engine or an MCU (Micro Control Unit) (not shown) which includes a processor, a memory, and an input/output device provided within a single chip so as to control overall operation thereof, but the present invention is not limited thereto. For example, all determination/drive/control means are applicable so long as the overall operation of the vehicle may be determined and thus driving thereof may be controlled.

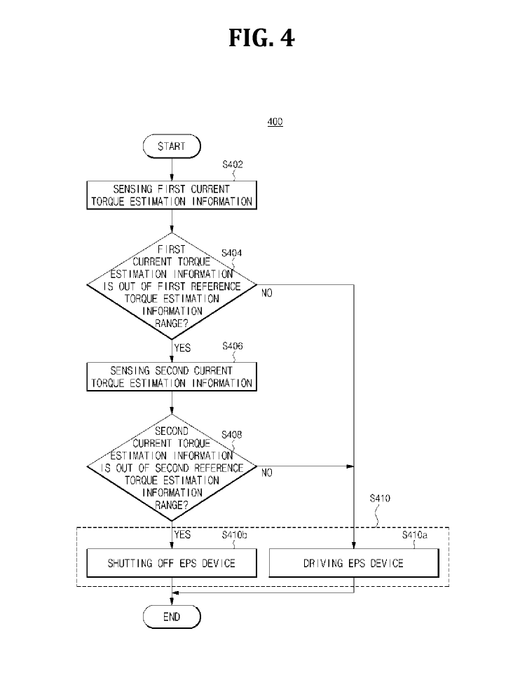

Hereinafter, a description will be given of an electric power steering control method using the electric power steering control apparatus 100 according to the first embodiment of the present invention with reference to FIG. 4.

FIG. 4 is a flowchart illustrating an electric power steering control method of the electric power steering control apparatus according to the first embodiment of the present invention.

Referring to FIG. 4, an electric power steering control method 400 of the electric power steering control apparatus 100 (see FIGS. 1 and 2) according to the first embodiment of the present invention includes a first current torque estimation signal output operation S402, a first determination operation S404, a second current torque estimation signal output operation S406, a second determination operation S408, and a drive operation S410 (S410a, S410b).

First, in the first current torque estimation signal output operation S402, first current torque estimation information is sensed and output.

Next, in the first determination operation S404, it is determined whether or not the first current torque estimation information is in a first state of being out of a first reference torque estimation information range.

In this case, after effectiveness of a current steering angle is identified by the first current torque estimation information, a current torque value may be estimated using a current vehicle speed range and the current steering angle.

For example, the current torque value may be estimated according to current steering angles when the current vehicle speed is in a high speed range L1 of FIG. 3 (for instance, 160 kph), when the current vehicle speed is in a middle speed range L2 of FIG. 3 (for instance, 100 kph), and when the current vehicle speed is in a low speed range L3 of FIG. 3 (for instance, 60 kph).

In addition, the current torque value may be estimated by the first current torque estimation information by means of additionally using correlation information between a current vehicle speed and a current steering angle, between a current lateral acceleration and a current gravitational acceleration, and between a wheelbase and an understeer gradient, which is indicated by the above-mentioned Equation 1.

Next, in the second current torque estimation signal output operation S406, second current torque estimation information is sensed and output if the first current torque estimation information is determined to be in the first state of being out of the first reference torque estimation information range.

Next, in the second determination operation S408, it is determined whether or not the second current torque estimation information is in a second state of being out of a second reference torque estimation information range.

In this case, after effectiveness of a current steering angle is identified by the second current torque estimation information, a current torque value may be estimated using a current vehicle speed range and the current steering angle.

For example, the current torque value may be estimated according to current steering angles when the current vehicle speed is in a high speed range L1 of FIG. 3 (for instance, 160 kph), when the current vehicle speed is in a middle speed range L2 of FIG. 3 (for instance, 100 kph), and when the current vehicle speed is in a low speed range L3 of FIG. 3 (for instance, 60 kph).

In addition, the current torque value may be estimated by the second current torque estimation information by means of additionally using correlation information between a current vehicle speed and a current steering angle, between a current lateral acceleration and a current gravitational acceleration, and between a wheelbase and an understeer gradient, which is indicated by the above-mentioned Equation 1.

Finally, in the drive operation S410a, an EPS device 30 of FIG. 2 is driven if the first current torque estimation information is not determined to be in the first state or the second current torque estimation information is not determined to be in the second state.

On the other hand, in the drive operation S410b, the EPS device 30 of FIG. 2 is shut off if the first current torque estimation information is determined to be in the first state or the second current torque estimation information is determined to be in the second state.

Accordingly, the electric power steering control apparatus 100 according to the first embodiment of the present invention includes the control unit 102, the first determination unit 104, the second determination unit 106, and the drive unit 108, and thus the electric power steering control method 400 according to the first embodiment of the present invention performs the first current torque estimation signal output operation S402, the first determination operation S404, the second current torque estimation signal output operation S406, the second determination operation S408, and the drive operation S410 (S410a, S410b).

Thus, the electric power steering control apparatus 100 and the electric power steering control method 400 according to the first embodiment of the present invention may allow the EPS device 30 to be driven using the second torque sensor 20 during failure of the first torque sensor 10 and to be shut off during failure of the second torque sensor 20.

Therefore, in accordance with the electric power steering control apparatus 100 and the electric power steering control method 400 according to the first embodiment of the present invention, since a posture of the vehicle may be stably controlled such that the vehicle is stably driven, it may be possible to previously prevent traffic accidents.

### Second Embodiment

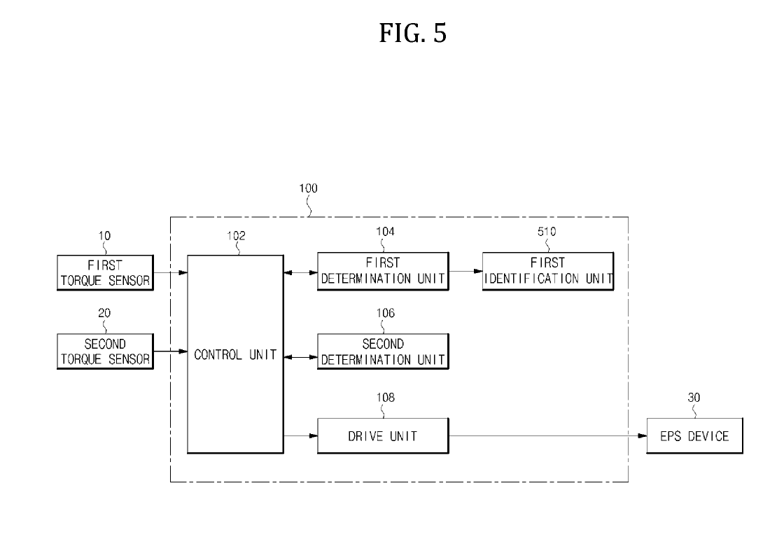

FIG. 5 is a block diagram illustrating an exemplary configuration of an electric power steering control apparatus according to a second embodiment of the present invention.

Referring to FIG. 5, an electric power steering control apparatus 500 according to a second embodiment of the present invention includes a control unit 102, a first determination unit 104, a second determination unit 106, and a drive unit 108, similarly to the electric power steering control apparatus 100 according to the first embodiment.

Since functions of respective components and organic connection relations therebetween applied to the electric power steering control apparatus 500 according to the second embodiment of the present invention are the same as those applied to the electric power steering control apparatus 100 according to the first embodiment, no detailed description thereof will be given.

Here, the electric power steering control apparatus 500 according to the second embodiment of the present invention further includes a first identification unit 510.

That is, if the first current torque estimation information is determined to be in the first state of being out of the first reference torque estimation information range, the first identification unit 510 is provided to identify abnormal condition of the first torque sensor 10.

In this case, although not shown, the first identification unit 510 includes a speaker (not shown), a light emitting member (not shown), and at least one of HMI (Human Machine Interface) module (not shown) and an HUD (Head-UP Display) module (not shown), which are provided in order for a driver to identify the information or state of the vehicle. Accordingly, the first identification unit 510 may identify the abnormal condition of the first torque sensor 10 through voice operation of the speaker (not shown), light emitting operation of the light emitting member (not shown), and at least one of HMI message display operation of the HMI module (not shown) and HUD message display operation of the HUD (not shown).

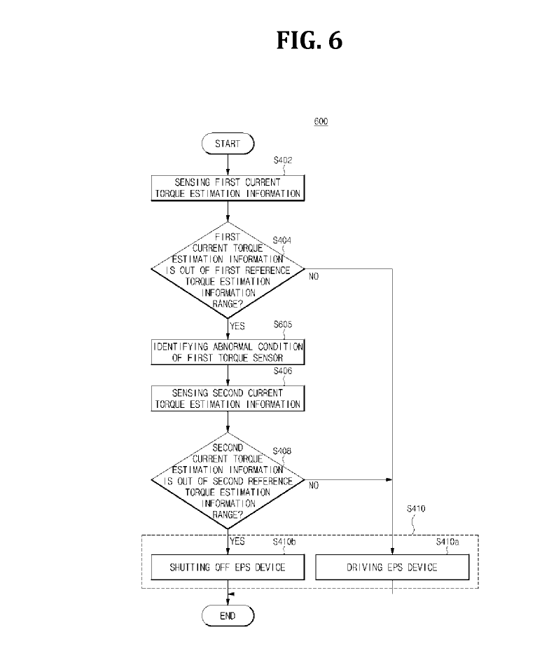

Hereinafter, a description will be given of an electric power steering control method using the electric power steering control apparatus 500 according to the second embodiment of the present invention with reference to FIG. 6.

FIG. 6 is a flowchart illustrating an electric power steering control method of the electric power steering control apparatus according to the second embodiment of the present invention.

Referring to FIG. 6, an electric power steering control method 600 of the electric power steering control apparatus 500 of FIG. 5 according to the second embodiment of the present invention includes a first current torque estimation signal output operation S402, a first determination operation S404, a second current torque estimation signal output operation S406, a second determination operation S408, and a drive operation S410 (S410a, S410b), similarly to the electric power steering control method 400 of the electric power steering control apparatus 100 of FIGS. 1 and 2 according to the first embodiment.

Since functions of respective components and organic connection relations therebetween applied to the electric power steering control method 600 of the electric power steering control apparatus 500 of FIG. 5 according to the second embodiment of the present invention are the same as those applied to the electric power steering control method 400 of the electric power steering control apparatus 100 of FIGS. 1 and 2 according to the first embodiment, no detailed description thereof will be given.

Here, the electric power steering control method 600 of the electric power steering control apparatus 500 of FIG. 5 according to the second embodiment of the present invention further performs a first identification operation S605 after the first determination operation S404.

For example, the electric power steering control method 600 of the electric power steering control apparatus 500 of FIG. 5 according to the second embodiment of the present invention may further perform the first identification operation S605 between the first determination operation S404 and the second current torque estimation signal output operation S406.

That is, in the first identification operation S605, abnormal condition of the first torque sensor 10 of FIG. 5 is identified if the first current torque estimation information is determined to be in the first state of being out of the first reference torque estimation information range.

Accordingly, the electric power steering control apparatus 500 according to the second embodiment of the present invention includes the control unit 102, the first determination unit 104, the second determination unit 106, the drive unit 108, and the first identification unit 510, and thus the electric power steering control method 600 according to the second embodiment of the present invention performs the first current torque estimation signal output operation S402, the first determination operation S404, the first identification operation S605, the second current torque estimation signal output operation S406, the second determination operation S408, and the drive operation S410 (S410a, S410b).

Thus, the electric power steering control apparatus 500 and the electric power steering control method 600 according to the second embodiment of the present invention may allow the EPS device 30 to be driven using the second torque sensor 20 during failure of the first torque sensor 10 and to be shut off during failure of the second torque sensor 20.

Therefore, in accordance with the electric power steering control apparatus 500 and the electric power steering control method 600 according to the second embodiment of the present invention, since a posture of the vehicle may be stably controlled such that the vehicle is stably driven, it may be possible to previously prevent traffic accidents.

In addition, in accordance with the electric power steering control apparatus 500 and the electric power steering control method 600 according to the second embodiment of the present invention, since the abnormal condition of the first torque sensor 10 of FIG. 5 may be recognized such that a driver rapidly copes with the present condition, it may be possible to further previously prevent traffic accidents.

### Third Embodiment

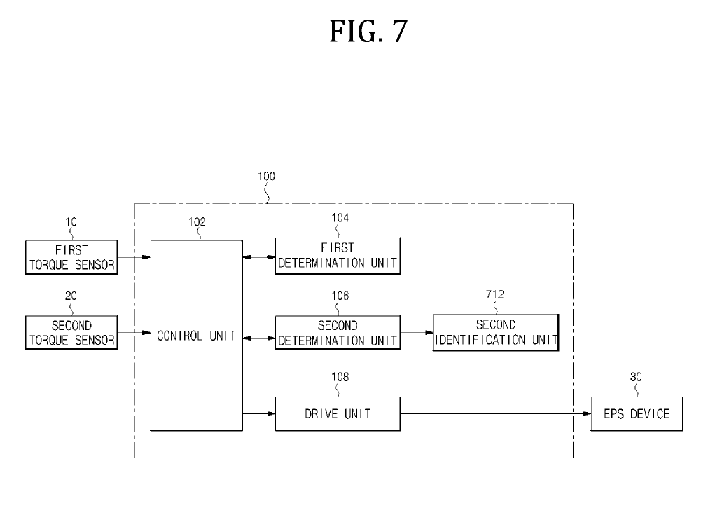

FIG. 7 is a block diagram illustrating an exemplary configuration of an electric power steering control apparatus according to a third embodiment of the present invention.

Referring to FIG. 7, an electric power steering control apparatus 700 according to a third embodiment of the present invention includes a control unit 102, a first determination unit 104, a second determination unit 106, and a drive unit 108, similarly to the electric power steering control apparatus 100 according to the first embodiment.

Since functions of respective components and organic connection relations therebetween applied to the electric power steering control apparatus 700 according to the third embodiment of the present invention are the same as those applied to the electric power steering control apparatus 100 according to the first embodiment, no detailed description thereof will be given.

Here, the electric power steering control apparatus 700 according to the third embodiment of the present invention further includes a second identification unit 712.

That is, if the second current torque estimation information is determined to be in the second state of being out of the second reference torque estimation information range, the second identification unit 712 is provided to identify abnormal condition of the second torque sensor 20.

In this case, although not shown, the second identification unit 712 includes a speaker (not shown), a light emitting member (not shown), and at least one of HMI (Human Machine Interface) module (not shown) and an HUD (Head-UP Display) module (not shown), which are provided in order for a driver to identify the information or state of the vehicle. Accordingly, the second identification unit 712 may identify the abnormal condition of the second torque sensor 20 through voice operation of the speaker (not shown), light emitting operation of the light emitting member (not shown), and at least one of HMI message display operation of the HMI module (not shown) and HUD message display operation of the HUD (not shown).

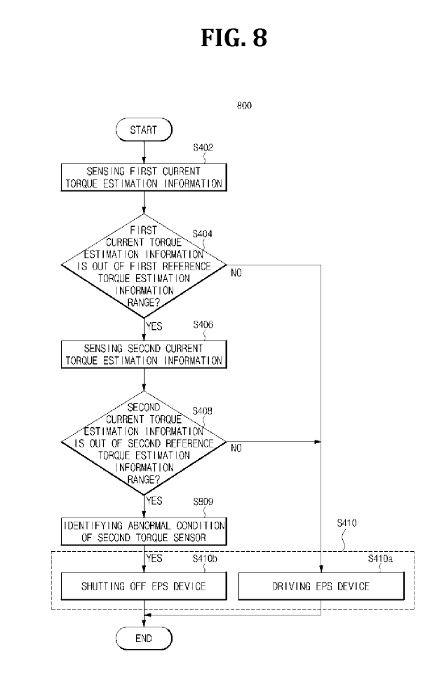

Hereinafter, a description will be given of an electric power steering control method using the electric power steering control apparatus 700 according to the third embodiment of the present invention with reference to FIG. 8.

FIG. 8 is a flowchart illustrating an electric power steering control method of the electric power steering control apparatus according to the third embodiment of the present invention.

Referring to FIG. 8, an electric power steering control method 800 of the electric power steering control apparatus 700 of FIG. 7 according to the third embodiment of the present invention includes a first current torque estimation signal output operation S402, a first determination operation S404, a second current torque estimation signal output operation S406, a second determination operation S408, and a drive operation S410 (S410a, S410b), similarly to the electric power steering control method 400 of the electric power steering control apparatus 100 of FIGS. 1 and 2 according to the first embodiment.

Since functions of respective components and organic connection relations therebetween applied to the electric power steering control method 800 of the electric power steering control apparatus 700 of FIG. 7 according to the third embodiment of the present invention are the same as those applied to the electric power steering control method 400 of the electric power steering control apparatus 100 of FIGS. 1 and 2 according to the first embodiment, no detailed description thereof will be given.

Here, the electric power steering control method 800 of the electric power steering control apparatus 700 of FIG. 7 according to the second embodiment of the present invention further performs a second identification operation S809 after the second determination operation S408.

For example, the electric power steering control method 800 of the electric power steering control apparatus 700 of FIG. 7 according to the third embodiment of the present invention may further perform the second identification operation S809 between the second determination operation S408 and the drive operation S410 (S410a, S410b).

That is, in the second identification operation S809, abnormal condition of the second torque sensor 20 of FIG. 7 is identified if the second current torque estimation information is determined to be in the second state of being out of the second reference torque estimation information range.

Accordingly, the electric power steering control apparatus 700 according to the third embodiment of the present invention includes the control unit 102, the first determination unit 104, the second determination unit 106, the drive unit 108, and the second identification unit 712, and thus the electric power steering control method 800 according to the third embodiment of the present invention performs the first current torque estimation signal output operation S402, the first determination operation S404, the second current torque estimation signal output operation S406, the second determination operation S408, the second identification operation S809, and the drive operation S410 (S410a, S410b).

Thus, the electric power steering control apparatus 700 and the electric power steering control method 800 according to the third embodiment of the present invention may allow the EPS device 30 to be driven using the second torque sensor 20 during failure of the first torque sensor 10 and to be shut off during failure of the second torque sensor 20.

Therefore, in accordance with the electric power steering control apparatus 700 and the electric power steering control method 800 according to the third embodiment of the present invention, since a posture of the vehicle may be stably controlled such that the vehicle is stably driven, it may be possible to previously prevent traffic accidents.

In addition, in accordance with the electric power steering control apparatus 700 and the electric power steering control method 800 according to the third embodiment of the present invention, since the abnormal condition of the second torque sensor 20 of FIG. 7 may be recognized such that a driver rapidly copes with the present condition, it may be possible to further previously prevent traffic accidents.

### Fourth Embodiment

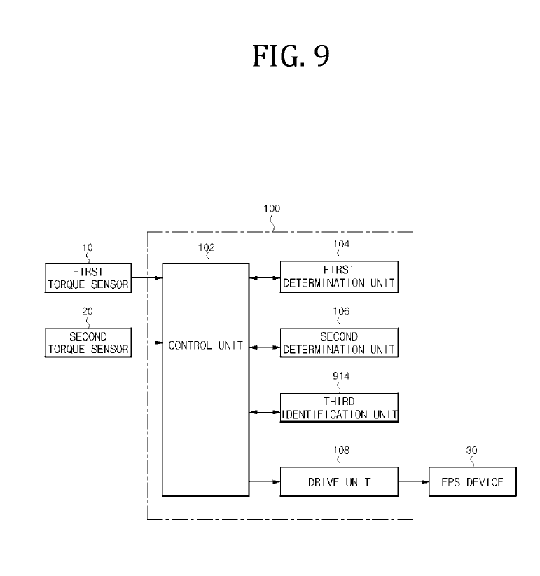

FIG. 9 is a block diagram illustrating an exemplary configuration of an electric power steering control apparatus according to a fourth embodiment of the present invention.

Referring to FIG. 9, an electric power steering control apparatus 900 according to a fourth embodiment of the present invention includes a first determination unit 104, a second determination unit 106, and a drive unit 108, similarly to the electric power steering control apparatus 100 according to the first embodiment.

Since functions of respective components and organic connection relations therebetween applied to the electric power steering control apparatus 900 according to the fourth embodiment of the present invention are the same as those applied to the electric power steering control apparatus 100 according to the first embodiment, no detailed description thereof will be given.

Here, the electric power steering control apparatus 900 according to the fourth embodiment of the present invention further includes a control unit 902 and a third identification unit 914.

In this case, the control unit 902 is provided such that a shut-off condition signal is further output.

That is, the third identification unit 914 is provided such that, when the EPS device 30 is shut off and the shut-off feedback signal is supplied from the control unit 902, shut-off condition of the EPS device 30 is identified according to control of the control unit 902.

In this case, although not shown, the third identification unit 914 includes a speaker (not shown), a light emitting member (not shown), and at least one of HMI (Human Machine Interface) module (not shown) and an HUD (Head-UP Display) module (not shown), which are provided in order for a driver to identify the information or state of the vehicle. Accordingly, the third identification unit 914 may identify the shut-off condition of the EPS device 30 through voice operation of the speaker (not shown), light emitting operation of the light emitting member (not shown), and at least one of HMI message display operation of the HMI module (not shown) and HUD message display operation of the HUD (not shown).

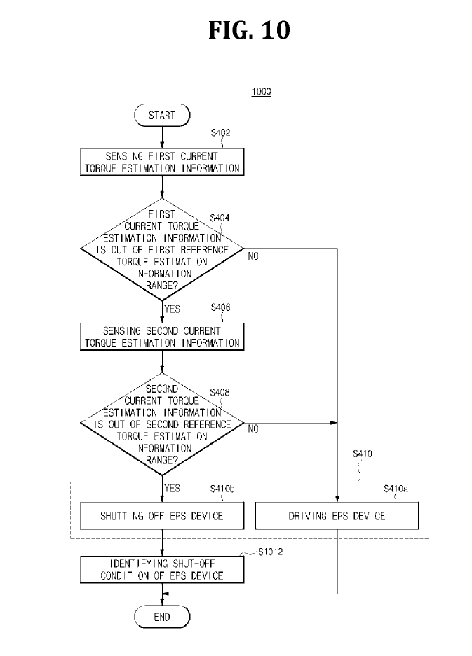

Hereinafter, a description will be given of an electric power steering control method using the electric power steering control apparatus 900 according to the fourth embodiment of the present invention with reference to FIG. 10.

FIG. 10 is a flowchart illustrating an electric power steering control method of the electric power steering control apparatus according to the fourth embodiment of the present invention.

Referring to FIG. 10, an electric power steering control method 1000 of the electric power steering control apparatus 900 of FIG. 9 according to the fourth embodiment of the present invention includes a first current torque estimation signal output operation S402, a first determination operation S404, a second current torque estimation signal output operation S406, a second determination operation S408, and a drive operation S410 (S410a, S410b), similarly to the electric power steering control method 400 of the electric power steering control apparatus 100 of FIGS. 1 and 2 according to the first embodiment.

Since functions of respective components and organic connection relations therebetween applied to the electric power steering control method 1000 of the electric power steering control apparatus 900 of FIG. 9 according to the fourth embodiment of the present invention are the same as those applied to the electric power steering control method 400 of the electric power steering control apparatus 100 of FIGS. 1 and 2 according to the first embodiment, no detailed description thereof will be given.

Here, the electric power steering control method 1000 of the electric power steering control apparatus 900 of FIG. 9 according to the fourth embodiment of the present invention further performs a third identification operation S1012 after the drive operation S410.

That is, in the third identification operation S1012, when the EPS device 30 of FIG. 9 is shut off and the shut-off feedback signal is supplied from the control unit 902, shut-off condition of the EPS device 30 of FIG. 9 is identified.

Accordingly, the electric power steering control apparatus 900 according to the fourth embodiment of the present invention includes the control unit 902, the first determination unit 104, the second determination unit 106, the drive unit 108, and the third identification unit 914, and thus the electric power steering control method 1000 according to the fourth embodiment of the present invention performs the first current torque estimation signal output operation S402, the first determination operation S404, the second current torque estimation signal output operation S406, the second determination operation S408, the drive operation S410 (S410a, S410b), and the third identification operation S1012.

Thus, the electric power steering control apparatus 900 and the electric power steering control method 1000 according to the fourth embodiment of the present invention may allow the EPS device 30 to be driven using the second torque sensor 20 during failure of the first torque sensor 10 and to be shut off during failure of the second torque sensor 20.

Therefore, in accordance with the electric power steering control apparatus 900 and the electric power steering control method 1000 according to the fourth embodiment of the present invention, since a posture of the vehicle may be stably controlled such that the vehicle is stably driven, it may be possible to previously prevent traffic accidents.

In addition, in accordance with the electric power steering control apparatus 900 and the electric power steering control method 1000 according to the fourth embodiment of the present invention, since the shut-off condition of the EPS device 30 of FIG. 9 may be recognized such that a driver rapidly copes with the present condition, it may be possible to further previously prevent traffic accidents.

As is apparent from the above description, in accordance with an electric power steering control apparatus and method, the following effects may be obtained.

First, since a vehicle is stably driven, traffic accidents may be previously prevented.

Second, since a driver rapidly copes with the present condition, traffic accidents may be further previously prevented.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric power steering control apparatus comprising:
a first determination unit which determines whether or not first current torque estimation information sensed by a first torque sensor is in a first state of being out of a preset first reference torque estimation information range;
a second determination unit which determines, if the first current torque estimation information is determined to be in the first state, whether or not second current torque estimation information sensed by a second torque sensor is in a second state of being out of a preset second reference torque estimation information range;
a drive unit which drives or shuts off an EPS (Electric Power Steering) device depending upon at least one determination of the first and second determination units; and
a control unit which controls the drive unit so that the EPS device is driven if the first current torque estimation information is not determined to be in the first state or the second current torque estimation information is not determined to be in the second state, or the EPS device is shut off if the first current torque estimation information is determined to be in the first state or the second current torque estimation information is determined to be in the second state.

2. The electric power steering control apparatus according to claim 1, wherein after effectiveness of a current steering angle is identified by the first and second current torque estimation information, a current torque value is estimated using a current vehicle speed range and the current steering angle.

3. The electric power steering control apparatus according to claim 1, wherein a current torque value is estimated by the first and second current torque estimation information by means of additionally using correlation information between a current vehicle speed and a current steering angle, between a current lateral acceleration and a current gravitational acceleration, and between a wheelbase and an understeer gradient.

4. The electric power steering control apparatus according to claim 1, further comprising:
a first identification unit which identifies abnormal condition of the first torque sensor if the first current torque estimation information is determined to be in the first state.

5. The electric power steering control apparatus according to claim 1, further comprising:
a second identification unit which identifies abnormal condition of the second torque sensor if the second current torque estimation information is determined to be in the second state.

6. The electric power steering control apparatus according to claim 1, further comprising:
a third identification unit provided such that, when the EPS device is shut off and a shut-off feedback signal is supplied from the control unit, shut-off condition of the EPS device is identified according to control of the control unit.

7. An electric power steering control method comprising:
performing a first current torque estimation signal output operation in which first current torque estimation information is sensed and output;
performing a first determination operation in which it is determined whether or not the first current torque estimation information is in a first state of being out of a first reference torque estimation information range;
performing a second current torque estimation signal output operation in which second current torque estimation information is sensed and output if the first current torque estimation information is determined to be in the first state;
performing a second determination operation in which it is determined whether or not second current torque estimation information is in a second state of being out of a second reference torque estimation information range; and
performing a drive operation in which an EPS device is driven if the first current torque estimation information is not determined to be in the first state or the second current torque estimation information is not determined to be in the second state, or the EPS device is shut off if the first current torque estimation information is determined to be in the first state or the second current torque estimation information is determined to be in the second state.

8. The electric power steering control method according to claim 7, wherein after effectiveness of a current steering angle is identified by the first and second current torque estimation information, a current torque value is estimated using a current vehicle speed range and the current steering angle.

9. The electric power steering control method according to claim 7, wherein a current torque value is estimated by the first and second current torque estimation information by means of additionally using correlation information between a current vehicle speed and a current steering angle, between a current lateral acceleration and a current gravitational acceleration, and between a wheelbase and an understeer gradient.

10. The electric power steering control method according to claim 7, further comprising:
performing, after performing the first determination operation, a first identification operation in which abnormal condition of a first torque sensor is identified if the first current torque estimation information is determined to be in the first state.

11. The electric power steering control method according to claim 7, further comprising:
performing, after performing the second determination operation, a second identification operation in which abnormal condition of a second torque sensor is identified if the second current torque estimation information is determined to be in the second state.

12. The electric power steering control method according to claim 7, further comprising:
performing, after performing the drive operation, a third identification operation in which, when the EPS device is shut off and a shut-off feedback signal is supplied, shut-off condition of the EPS device is identified.
